(19) United States
(12) Patent Application Publication
(10) Pub. No.: US 2014/0352269 A1
(43) Pub. Date: Dec. 4, 2014

(54) DUST WASH SYSTEM WITH PURGE GAS

(71) Applicant: Hatch Ltd., Mississauga (CA)

(72) Inventors: Michael Trovant, Toronto (CA); Arran Thomas McGrath, Mississauga (CA); Daniel Scott, Burlington (CA)

(73) Assignee: Hatch Ltd., Mississauga, ON (CA)

(21) Appl. No.: 14/365,859

(22) PCT Filed: Dec. 13, 2012
(86) PCT No.: PCT/CA2012/001144

§ 371 Date: Jun. 16, 2014

Related U.S. Application Data
(60) Provisional application No. 61/576,240, filed on Dec. 15, 2011.

(51) Int. Cl. B01D 45/04

(52) U.S. Cl. CPC B01D 45/04
USPC 55/428

(57) ABSTRACT

A chute receives contaminant gas-laden dust from a dust collector. At least one gas injector provides an upward flow of purge gas in the chute to release contaminant gas entrained with the dust. Downstream areas are maintained at positive pressure relative to upstream areas. A purge hopper arranged below the chute collects the dust. Dust handling apparatuses allow the upward flow of the purge and contaminant gases. Movable flaps in the dust handling apparatuses include perforations that may be capped to vary the gas flow rate. A dust discharge apparatus discharges washed dust from the purge hopper.

### TECHNICAL FIELD

The present disclosure relates to the washing and discharging of industrial process dust, and particularly to a system employing gas to purge dust of other gases prior to discharge.

### BACKGROUND

The following paragraphs are not an admission that anything discussed in them is prior art or part of the knowledge of persons skilled in the art.

Some industrial and commercial processes generate dust which must be removed from the working environment. Dust may be produced as a component of an off-gas stream, where it is conveyed by the gas stream within a gas handling system. In other instances, dust may be generated by activities, such as crushing or conveying, and a dedicated dust handling system may be employed to capture dust emissions at their source.

Irrespective of its origin, dust may be generally conveyed within a gas stream to a dust collection apparatus, which removes dust particles from the gas. In the dust collection apparatus, the dust may accumulate in a temporary storage vessel such as a hopper, which is periodically emptied in order to make use of or dispose of the dust.

As dust is removed from a gas stream and sent to a storage vessel, it may entrain a portion of the conveying gas. This may be generally undesirable, as dust within the storage vessel is contaminated by the conveying gas, which may be toxic and/or combustible. Workers may be exposed to the toxic gas, or an explosive gas mixture may develop within the dust handling system.

For example, the production of calcium carbide in a submerged arc furnace uses a feed mixture of coke and lime in the following reaction:

CaO+3C→CaC₂+CO

This process generates carbon monoxide gas, which may be entrained with dust particles present in the feed material. The carbon dioxide-rich gas may be cleaned in a dry dust collector, in which the dust is temporarily stored in a hopper. The toxic gas may be released upon emptying the hopper. There is the additional risk of an explosive gas mixture developing within the hopper.

### SUMMARY OF THE DISCLOSURE

The following summary is intended to introduce the reader to the more detailed description that follows and not to define or limit the claimed subject matter.

According to an aspect of the present disclosure, a system for washing dust may include: a chute for receiving the dust from a dust collector, and facilitating a downward flow of the dust; and at least one gas injector, adapted to provide an upward flow of purge gas in the chute to release contaminant gas entrained with the dust.

The system may further include a first dust handling apparatus for connecting the chute to the dust collector. The first dust handling apparatus may include a control valve adapted to control gas and solids flow between the chute and the dust collector. When in a closed position, the control valve may block the downward flow of the dust into the chute, and may permit the upward flow of the purge and contaminant gases out of the chute. When in an open position, the control valve may permit the downward flow of the dust into the chute. The first dust handling apparatus may include a slide gate mechanism that is closable to block gas and solids flow between the chute and the dust collector.

The system may further include a purge hopper arranged below the chute, for collecting the dust from the chute. The at least one gas injector may include a first gas injector connected to a sidewall of the purge hopper.

The system may further include a second dust handling apparatus for connecting the purge hopper to the chute. The second dust handling apparatus may include a control valve adapted to control gas and solids flow between the purge hopper and the chute. When in a closed position, the control valve may block the downward flow of the dust into the purge hopper, and may permit the upward flow of the purge and contaminant gases between the purge hopper and the chute. When in an open position, the control valve may permit the downward flow of the dust into the purge hopper. The second dust handling apparatus may include a slide gate mechanism that is closable to block gas and solids flow between the purge hopper and the chute. The at least one gas injector may include a second gas injector connected to a sidewall of the chute.

The system may further include a dust discharge apparatus for discharging the dust from the purge hopper. The dust discharge apparatus may include a control valve adapted to control the flow of dust out of the purge hopper. When in a closed position, the control valve may blocks flow of the dust and the purge and contaminant gases out of a bottom of the purge hopper. The dust discharge apparatus may include a slide gate mechanism that is closable to block gas and solids flow out of the purge hopper.

According to another aspect of the present disclosure, a dust handling apparatus may include: a body for connecting upstream and downstream areas of a dust washing system; and at least one flap arranged in the body, and adapted to block downward flow of dust between the upstream and downstream areas, and permit upward flow of purge gas between the downstream and upstream areas.

The at least one flap may include a plurality of perforations. At least a portion of the perforations may include an insert having an opening extending therethrough. The apparatus may further include a plurality of caps adapted for attachment to the inserts, to obstruct the purge gas from flowing through the respective perforations.

The at least one flap may be movable between an open position in which the dust is permitted to flow between the upstream and downstream areas, and a closed position in which the dust is blocked from flowing between the upstream and downstream areas. The at least one flap may include first and second flaps that generally enclose a plenum within the body. The first and second flaps may be movable independently between the open and closed positions, to pass the dust sequentially from the upstream area to the plenum, and from the plenum to the downstream area.

According to another aspect of the present disclosure, a method of washing dust may include: directing a downward flow of the dust from an upstream area to a downstream area; and directing an upward flow of a purge gas from the downstream area to the upstream area, to release contaminant gas entrained with the dust.

The method may further include maintaining the downstream area at a positive pressure relative to the upstream area. The method may further include directing the downward flow of the dust from a dust collector into a chute. The method may further include blocking the downward flow of the dust between the dust collector and the chute. The method may further include opening a control valve between the dust collector and the chute, to permit the dust to flow therethrough. The step of opening may include sequentially opening and closing first and second flaps of the control valve. The method may further include varying gas flow rate between the chute and the dust collector. The step of varying may include selectively capping or uncapping perforations in the flaps.

The method may further include collecting the dust in a purge hopper arranged below the chute. The method may further include injecting the purge gas into the purge hopper, and flowing the purge gas upwardly into the chute. The method may further include closing a slide gate mechanism between the purge hopper and the chute, and injecting the purge gas into the chute. The method may further include discharging the dust from the purge hopper. The method may further include blocking the downward flow of the dust between the chute and the purge hopper. The method may further include opening a control valve between the chute and the purge hopper, to permit the dust to flow therethrough. The step of opening may include sequentially opening and closing first and second flaps of the control valve. The method may further include varying gas flow rate between the purge hopper and the chute. The step of varying may include selectively capping or uncapping perforations in the flaps.

### BRIEF DESCRIPTION OF THE DRAWINGS

In order that the claimed subject matter may be more fully understood, reference will be made to the accompanying drawings, in which:

FIG. 1 is a side view of a dust wash system according to an example;

FIG. 2 is a flow diagram of the system of FIG. 1;

FIG. 3 is a detailed side view of an example of a dust discharge apparatus;

FIG. 4 is a detailed side view of an example of a dust handling apparatus;

FIG. 5 is a plan view of a portion of the dust handling apparatus of FIG. 4;

FIG. 6 is a sectional view of a portion of the dust handling apparatus of FIG. 4;

FIG. 7 is a schematic representation of dust being washed in a chute of the system of FIG. 1; and

FIG. 8 is another sectional view of the portion of the dust handling apparatus of FIG. 4, and including flow of purge gas therethrough.

### DETAILED DESCRIPTION

In the following description, specific details are set out to provide examples of the claimed subject matter. However, the examples described below are not intended to define or limit the claimed subject matter. It will be apparent to those skilled in the art that many variations of the specific examples may be possible within the scope of the claimed subject matter.

For simplicity and clarity of illustration, where considered appropriate, reference numerals may be repeated among the drawings to indicate corresponding or analogous elements or steps.

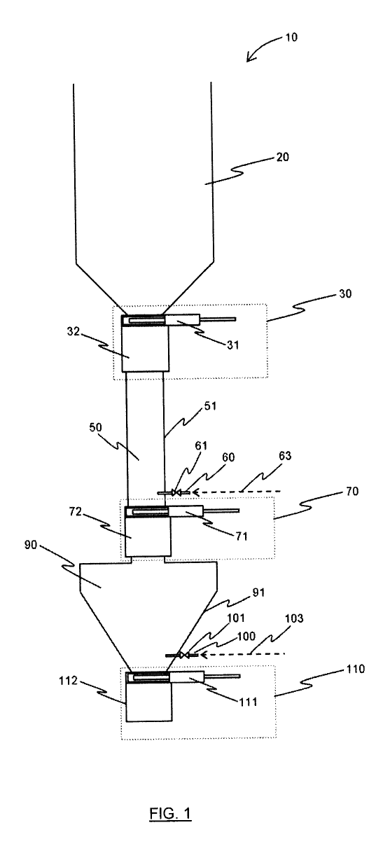

Referring to FIG. 1, an example of a dust wash system is illustrated generally at 10. Dust is washed in the system 10 using purge gas to release contaminant gas entrained with the dust.

In the example illustrated, the system 10 includes a dust collector 20, a first dust handling apparatus 30, a chute 50, a first gas injector 60, a second dust handling apparatus 70, a purge hopper 90, a second gas injector 100, and a dust discharge apparatus 110.

Contaminant gas-laden dust captured by the dust collector 20 is discharged into the chute 50 through the first dust handling apparatus 30. The first dust handling apparatus 30 includes a slide gate mechanism 31 and a control valve 32. The slide gate mechanism 31 is open during normal operation and may be closed to isolate the downstream portions of the system 10 for maintenance. The control valve 32 controls the flow of gas and solids between the dust collector 20 and the chute 50. In some examples, the control valve 32, when in a closed position, blocks the downward flow of dust. However, the control valve 32 may be permeable to gas, in order to allow the upward flow of gas between the chute 50 and the dust collector 20 when the control valve 32 is in the closed position.

Dust particles travel downward through the chute 50 and are discharged through the second dust handling apparatus 70 into the purge hopper 90. The second dust handling apparatus 70 includes a slide gate mechanism 71 and a control valve 72. The slide gate mechanism 71 is open during normal operation, except when the purge hopper 90 is discharging. In this case, the slide gate mechanism 71 may be closed in order to prevent further flow of dust from the chute 50 into the purge hopper 90. The control valve 72 controls the flow of gas and solids between the chute 50 and the purge hopper 90. In some examples, the control valve 72, when in a closed position, blocks the downward flow of dust. However, the control valve 72 may be permeable to gas, in order to allow the upward flow of gas between the purge hopper 90 and the chute 50 when the control valve 72 is in the closed position.

As the purge hopper 90 accumulates dust and reaches capacity, it discharges clean dust through the dust discharge apparatus 110, for example, into the external environment for disposal. The dust discharge apparatus 110 includes of a slide gate mechanism 111 and a control valve 112. The slide gate mechanism 111 is held in a closed position until the purge hopper 90 is to be emptied, at which point the slide gate mechanism 111 is moved to an open position. The control valve 112, which may not be permeable to gas, is also held in a closed position until the purge hopper 90 is to be emptied, at which point the control valve 112 is moved to a variable open position to control the rate of discharge of clean dust from the system 10.

During normal operation, a purge gas stream 103 is injected through a sidewall 91 of the purge hopper 90 using the second gas injector 100. In the example illustrated, flow of the purge gas stream 103 into the purge hopper 90 is controlled by a flow control valve 101. The second gas injector 100 may be inserted at any point on the sidewall 91 of the purge hopper 90, as long as the pressure within the purge hopper 90 is maintained above the pressure within the dust collector 20. This ensures a generally upward flow of gas, through the second dust handling apparatus 70 and into the chute 50. Downward flow of gas is prevented by the dust discharge apparatus 110.

Gas flows upward through the chute 50 due to the pressurization of the purge hopper 90. Dust particles fall downward through the chute 50 and mix with the upwardly flowing purge gas, thereby releasing entrained contaminant gas, described in further detail below. The released contaminant gas flows upward with the purge gas, and the cleaned dust particles accumulate at the bottom of the chute 50.

During discharge of the purge hopper 90, the slide gate mechanism 71 of the second dust handling apparatus 70 is closed to prevent further flow of dust from the chute 50 into the purge hopper 90. Additionally, the purge gas stream 103 is stopped by closing the flow control valve 101, as this gas would simply flow out of the system 10 through the open outlet of the dust discharge apparatus 110. Accordingly, in order to maintain the upward flow of purge gas through the chute 50, a purge gas stream 63 may be injected through a sidewall 51 of the chute 50 using the first gas injector 60. In the example illustrated, the purge gas stream 63 into the chute 50 is controlled by a flow control valve 61. The first gas injector 60 is located near the bottom of the chute 50, and the purge gas stream 63 may be injected at a higher pressure than the pressure within the dust collector 20, in order to produce a generally upward flow of purge gas through the chute 50. This establishes a counter-current flow between the dust particles and the purge gas, and prevents the accumulation of contaminant gas in the chute 50 during dust discharge operations. During injection of the purge gas stream 63, the slide gate mechanism 71 of the second dust handling apparatus 70 may also prevent the downward flow of purge gas into the purge hopper 90.

In some examples, the purge gas streams 63, 103 may carry an inert gas, such as a noble gas, or nitrogen. In other examples, the purge gas streams 63, 103 may carry air, which would not be suitable for cleaning dust entrained with carbon-monoxide (as air would form an explosive mixture with carbon monoxide), but if the contaminant gas is toxic but non-flammable (such as carbon dioxide), then air may be used to wash the dust. Generally, as used herein, the term purge gas refers to a gas that is: non-reactive with the process gas, at any expected mixture concentration; non-combustible with the process gas, at any expected mixture concentration; and non-toxic.

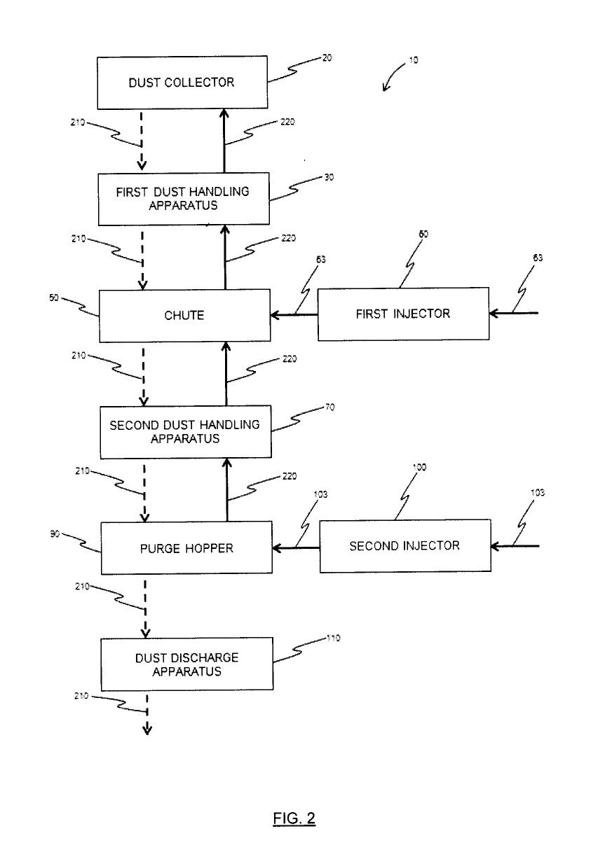

Referring now to FIG. 2, a dust stream 210 flows downwardly through the system 10 and is expelled by the dust discharge apparatus 110. During normal operation, the purge gas stream 103 is injected into the purge hopper 90 using the second gas injector 100. Again, this establishes a positive pressure within the purge hopper 90 relative to the dust collector 20, which produces an upward flow of a purge gas stream 220 through the chute 50 and into the dust collector 20. During discharge of the purge hopper 90, the second dust handling apparatus 70 is closed, which prevents the purge gas stream 103 from flowing upward as the purge gas stream 220. In this case, the purge gas stream 63 is injected into the chute 50 using the first gas injector 60. This maintains the upward flow of the purge gas stream 220 through the chute 50 and into the dust collector 20. Note that only one of the purge gas streams 63, 103 may be flowing at any given time.

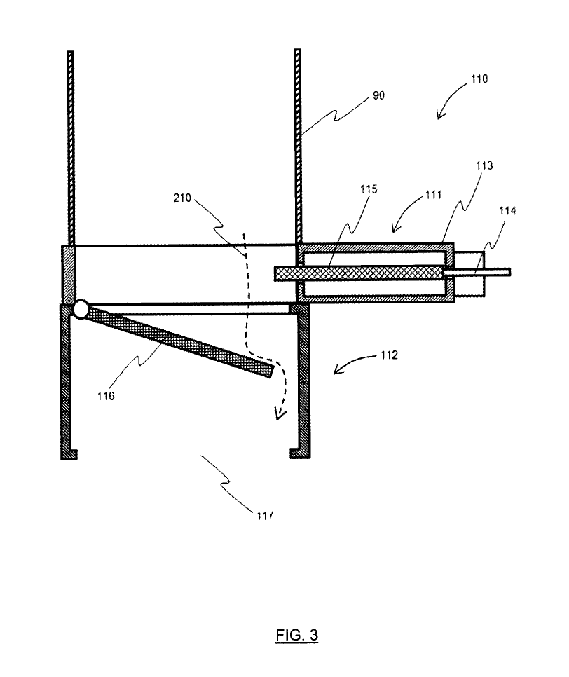

Referring now to FIG. 3, a particular example of the dust discharge apparatus 110 is shown to include the slide gate mechanism 111 and the control valve 112, connected to the purge hopper 90. The slide gate mechanism 111 is shown in an open position. The slide gate mechanism 111 is normally maintained in a closed position, in order to prevent the escape of gas and solids through an outlet 117 of the system. The slide gate mechanism 111 is opened by retracting a gate 115 into a bonnet 113 using an actuator 114. Conversely, the gate 115 is extended out of the bonnet 113 using the actuator 114 to close the slide gate mechanism 111.

In the example illustrated, the control valve 112 is configured as a single dump valve, having a flap 116. The control valve 112 is normally maintained in a closed position, and is opened to discharge the dust stream 210 from the purge hopper 90. The control valve 112 is opened by opening the flap 116. The control valve 112 is impermeable to gas flow, in order to prevent the release of gas from the purge hopper 90 into the external environment through the outlet 117.

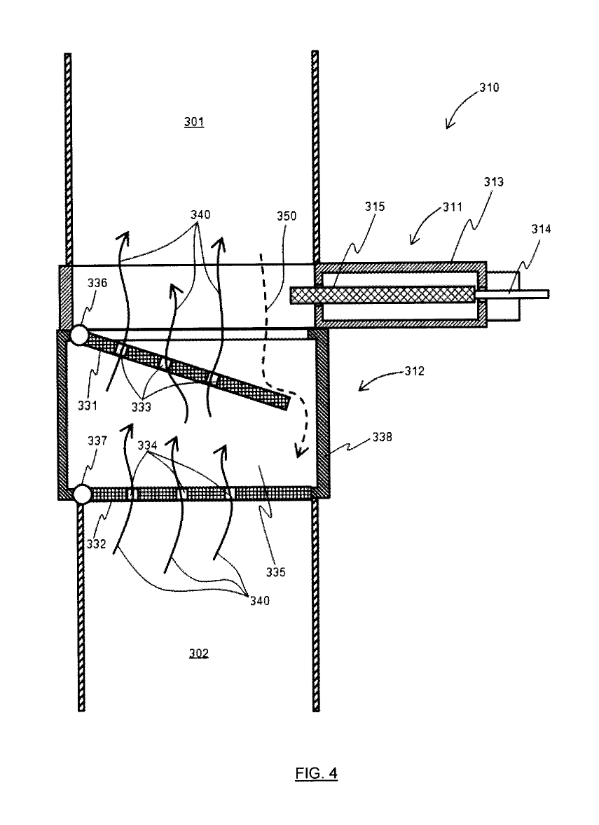

Referring to FIG. 4, a particular example of a dust handling apparatus 310 is shown, which may be employed in the system 10 as the first dust handling apparatus 30, the second dust handling apparatus 70, or both. Similar to the dust discharge apparatus 110, the dust handling apparatus 310 includes a slide gate mechanism 311 and a control valve 312. The slide gate mechanism 311 is shown in an open position. The slide gate mechanism 311 is normally maintained in the open position, and is closed in order to isolate a downstream area 302 from an upstream area 301. The slide gate mechanism 311 is opened by retracting a gate 315 into a bonnet 313 using an actuator 314. Conversely, the gate 315 is extended out of the bonnet 313 using the actuator 314 to close the slide gate mechanism 311. When closed, the slide gate mechanism 311 blocks both gas flow 340 and solids flow 350 between the upstream area 301 and the downstream area 302. As illustrated, the gas flow 340 is upwardly moving, whereas the solids flow 350 is downwardly moving.

In the example illustrated, the control valve 312 is configured as a double dump valve, having a first flap 331 and a second flap 332. The first flap 331 and the second flap 332 enclose a plenum 335 within a body 338. The first flap 331 is connected to the body 338 by hinges 336. The second flap 332 is connected to the body 338 by hinges 337.

During normal operation, the control valve 312 controls the flow of gas and solids through the dust handling apparatus 310. To allow the solids flow 350 to pass downwardly, the first flap 331 opens and the solids flow 350 pass from the upstream area 301 into the plenum 335. The first flap 331 then closes and the second flap 332 opens to allow the solids flow 350 into the downstream area 302.

This sequence may be repeated continuously, with a cyclic frequency limited generally by a capacity of the plenum 335 between the flaps 331, 332. In some examples, the cyclic frequency may be selected to be higher than is necessary, so as to approximate a continuous process, and to provide a reasonable buffer volume to avoid jamming of the flaps 331, 332.

Generally, at least one of the flaps 331, 332 is closed to prevent a large amount of contaminant gas from passing through the dust handling apparatus 310. Furthermore, it should be appreciated that when one or more of the flaps 331, 332 are open, the overall resistance of the dust handling apparatus 310 to gas flow is substantially reduced. With less resistance, there is more downward flow of the contaminant gas, and therefore more upward flow of the purge gas is required to counteract the contaminant gas. Consequently, the amount of time that each of the flaps 331, 332 is open per cycle may be minimized, so as to minimize the overall purge gas requirements.

In this manner, the flaps 331, 332 of the dust handling apparatus 310 generally isolate the upstream area 301 from the downstream area 302. The gas flow 340, including both purge and contaminant gases, is achieved by maintaining the downstream area 302 at a higher pressure than the upstream area 301. A pressure difference may be produced, for example, by injecting pressurized purge gas into the downstream area 302. In the example illustrated, the pressure difference also causes the gas flow 340 to flow through perforations 334 of the second flap 332, and through perforations 333 of the first flap 331.

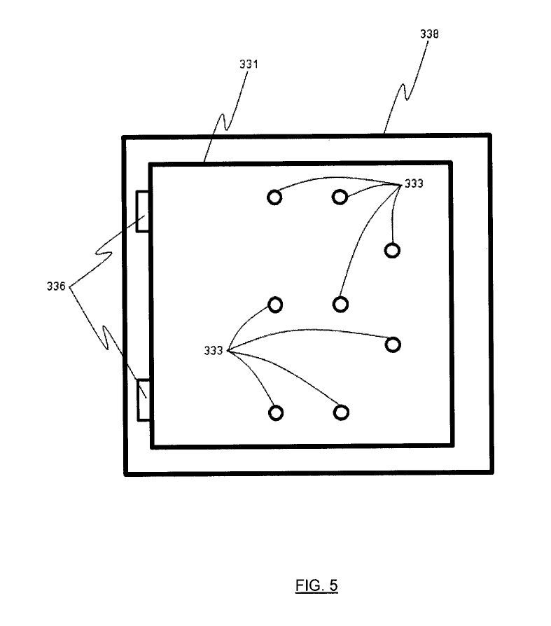

Shown in FIG. 5, the perforations 333 through the first flap 331 allow gas flow through the first flap 331, even when in the closed position. The perforations 334 in the second flap 332 may be arranged in a similar manner. The number and positioning of the perforations 333, 334 may be varied, depending on operating conditions.

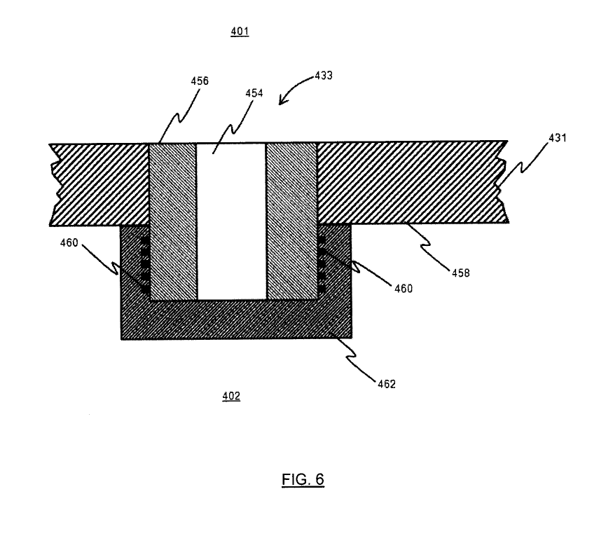

In some examples, referring to FIG. 6, a perforation 433 through a flap 431 (which may be employed in the dust handling apparatus 310 as the first flap 331, the second flap 332, or both) is fitted with a hollow cylindrical insert 456 to allow fluid communication between a downstream area 402 and an upstream area 401. The insert 456 may be fixed in place by press fit. An opening 454 extends through the insert 456. The insert 456 may extend beyond a bottom surface 458 of the flap 431, and include threads 460. A complementary threaded cap 462 may be attached to the insert 456 to obstruct gas flow through the perforation 433.

However, the cap 462 may be removable from the insert 456 so that gas may flow through the perforation 433. Accordingly, the flap 431 may be manufactured with a plurality of the perforations 433, at least a portion of which are fitted with the insert 456. Gas flow through the flap 431 may then be adjusted by selectively capping the inserts 456 using the caps 462.

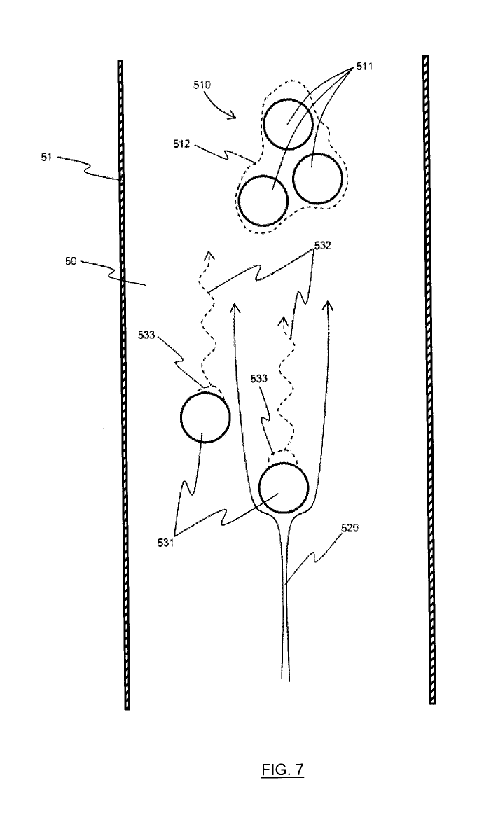

Referring to FIG. 7, within the sidewall 51 of the chute 50, a dust agglomeration 510 (not drawn to scale) includes dust particles 511 and entrained contaminant gas 512. The entrained contaminant gas 512 may be trapped in voids between the dust particles 511. Upward flow of purge gas 520 breaks up the dust agglomerations 510, causing isolation of dust particles 531 and release of contaminant gas 532. The contaminant gas 532 flows upwardly through the chute 50 along with the purge gas 520, due to buoyancy and convection. As the dust particles 531 individually continue to travel downwardly through the chute 50, any contaminant gas pockets 533 remaining will be progressively reduced and eventually washed upward by interaction with the purge gas 520. Due to the upward flow of purge gas through the system 10, the dust washing mechanism may also occur within plenums of the control valves 32, 72, within the purge hopper 90, and within the dust collector 20. In each case, dust flowing out of the given vessel will have a smaller concentration of contaminant gas than dust flowing into the same vessel, due to the washing mechanism. Furthermore, even without a distinct counter-current flow between purge gas and dust, the continuous flow of purge gas into the system 10 will tend to dilute and displace at least a portion of the contaminant gas within a given vessel. By this dilution mechanism, dust flowing out of the given vessel will have a smaller concentration of contaminant gas than dust flowing into the same vessel.

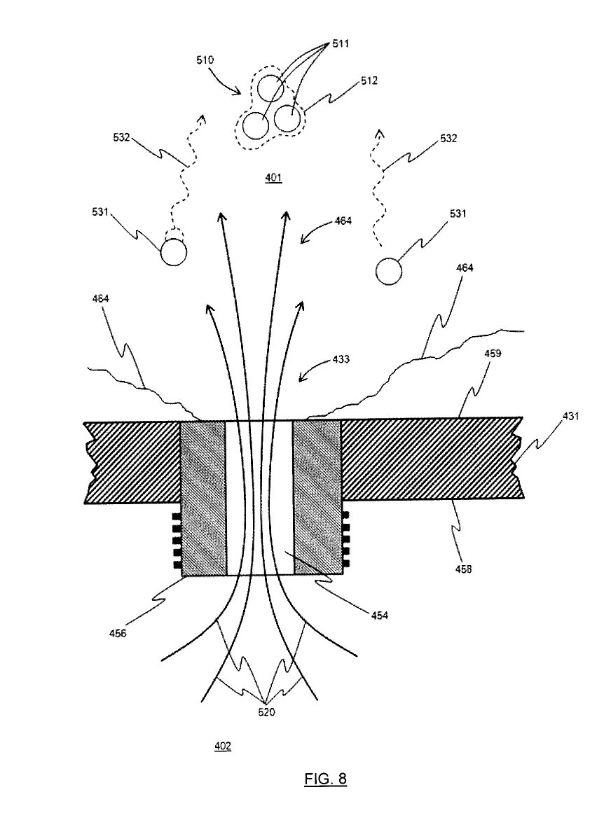

Referring to FIG. 8, the insert 456 is uncapped, allowing the purge gas 520 to flow through the opening 454 between the downstream area 402 and the upstream area 401. If a pressure differential between the areas 402, 401 is sufficiently high, the perforation 433 forms a gas jet 464 which is expelled into the upstream area 401. The dust agglomerations 510, conveying the entrained contaminant gas 512, travel downwardly through the upstream area 401 and are exposed to the relatively high velocity flow of the gas jet 464. The gas jet 464 tends to break up the dust agglomerations 510 into the dust particles 531, and the contaminant gas 532 is stripped from the dust particles 531.

The contaminant gas 532 may travel upwards through the upstream area 401 with the flow from the gas jet 464. On the other hand, the dust particles 531 accumulate on a top surface 459 of the flap 431, but are prevented from settling on or near the opening 454 of the insert 456 by the action of the gas jet 464. Consequently, the flap 431 may be effectively impermeable to dust flow between the areas 401, 402 when closed.

It will be appreciated by those skilled in the art that many variations are possible within the scope of the claimed subject matter. The examples that have been described above are intended to be illustrative and not defining or limiting.

1. A system for washing dust, comprising:
a chute for receiving the dust from a dust collector, and facilitating a downward flow of the dust; and
at least one gas injector, adapted to provide an upward flow of purge gas in the chute to release contaminant gas entrained with the dust.

2. The system of claim 1, further comprising a first dust handling apparatus for connecting the chute to the dust collector.

3. The system of claim 2, wherein the first dust handling apparatus comprises a control valve adapted to control gas and solids flow between the chute and the dust collector.

4. The system of claim 3, wherein, when in a closed position, the control valve blocks the downward flow of the dust into the chute, and permits the upward flow of the purge and contaminant gases out of the chute, and wherein, when in an open position, the control valve permits the downward flow of the dust into the chute.

5. (canceled)

6. The system of claim 2, wherein the first dust handling apparatus comprises a slide gate mechanism that is closable to block gas and solids flow between the chute and the dust collector.

7. The system of claim 1, further comprising a purge hopper arranged below the chute, for collecting the dust from the chute.

8. The system of claim 7, wherein the at least one gas injector comprises a first gas injector connected to a sidewall of the purge hopper.

9. The system of claim 8, further comprising a second dust handling apparatus for connecting the purge hopper to the chute, and wherein the second dust handling apparatus comprises a control valve adapted to control gas and solids flow between the purge hopper and the chute.

10. (canceled)

11. The system of claim 9, wherein, when in a closed position, the control valve blocks the downward flow of the dust into the purge hopper, and permits the upward flow of the purge and contaminant gases between the purge hopper and the chute.

12. The system of claim 11, wherein, when in an open position, the control valve permits the downward flow of the dust into the purge hopper.

13. The system of claim 9, wherein the second dust handling apparatus comprises a slide gate mechanism that is closable to block gas and solids flow between the purge hopper and the chute.

14. The system of claim 13, wherein the at least one gas injector comprises a second gas injector connected to a sidewall of the chute.

15. The system of claim 1, further comprising a dust discharge apparatus for discharging the dust from the purge hopper, and wherein the dust discharge apparatus comprises a control valve adapted to control the flow of dust out of the purge hopper.

16. (canceled)

17. The system of claim 16, wherein, when in a closed position, the control valve blocks flow of the dust and the purge and contaminant gases out of a bottom of the purge hopper.

18. The system of claim 15, wherein the dust discharge apparatus comprises a slide gate mechanism that is closable to block gas and solids flow out of the purge hopper.

19. A dust handling apparatus, comprising:
a body for connecting upstream and downstream areas of a dust washing system; and
at least one flap arranged in the body, and adapted to block downward flow of dust between the upstream and downstream areas, and permit upward flow of purge gas between the downstream and upstream areas.

20. The apparatus of claim 19, wherein the at least one flap comprises a plurality of perforations, and wherein at least a portion of the perforations comprise an insert having an opening extending therethrough.

21. (canceled)

22. The apparatus of claim 21, further comprising a plurality of caps adapted for attachment to the inserts, to obstruct the purge gas from flowing through the respective perforations.

23. The apparatus of claim 19, wherein the at least one flap is movable between an open position in which the dust is permitted to flow between the upstream and downstream areas, and a closed position in which the dust is blocked from flowing between the upstream and downstream areas.

24. The apparatus of claim 23, wherein the at least one flap comprises first and second flaps that generally enclose a plenum within the body, and where the first and second flaps are movable independently between the open and closed positions, to pass the dust sequentially from the upstream area to the plenum, and from the plenum to the downstream area.

25-43. (canceled)
